(19) United States
(12) Patent Application Publication
(10) Pub. No.: US 2003/0076585 A1
(43) Pub. Date: Apr. 24, 2003

(54) Optical system for enhancing the image from a microscope's high power objective lens

(76) Inventor: Robert S. Ledley, Laurel, MD (US)

Correspondence Address: Robert Steven Ledley, Naional Biomedical Research Fdn,, Georgetown Univ., Box 571414, Washingtond, DC, 20057-1414, US

(21) Appl. No.: 10/212,137

(22) Filed: Aug. 6, 2002

Related U.S. Application Data
(60) Provisional application No. 60/310,266, filed on Aug. 7, 2001.

(51) Int. Cl. G02B 21/00

(52) U.S. Cl. 359/368; 359/381; 359/380

(57) ABSTRACT

This invention discloses an optical system for enhancing the image from a microscope's high power objective lens that permits the simultaneous viewing of an object at both high and low magnifications through a single high power objective lens. This is accomplished by the mounting of high and low power lens train tubes on a microscope body and by directing a light source through a microscope's high power objective lens, then through beam splitters and then through said high and low power lens train tubes.

The enhancement to the optical microscope permits the simultaneous viewing of a specimen at both high and low magnifications through a single high power objective lens. A magnified image of a specimen is directed through beam splitters, which creates multiple equivalent specimen beams. One of these beams is directed through a high power lens train tube, which magnifies specimen images to produce high power images. The other beams are directed through low power lens train tubes. Directing a beam through a low power lens train tube reduces the image diameter to a size suitable for viewing and magnifies said image to a low power. All of these magnified images can be viewed at the same time in parallel or sequentially, one or more at a time.

### BACKGROUND

This invention relates to an optical system that permits one to view an object at simultaneous high and low power magnifications through a single high power objective lens.

A microscope's high power, (100×) objective lens has a high numerical aperture, which means that it collects a great deal of light for its size. The actual area of the specimen imaged by these high power microscope objective lenses can be very large and can be comparable to the area of the specimen imaged by a low power (20×) objective lens. To get the 100× objective magnification, only a very small area in the center of the image is shown to the final magnifier or ocular. This small portion of the image is effectively flat, even when magnified by the ocular. The nature of the ocular depends on the image receiving device, such as the human eye, a video camera, a digital scanner, etc. The depth of focus D of a lens is approximated by λ÷(4×(N.A.)²) for visible light, where λ is the wave length of the light and N.A. is the numerical aperture of the lens. The numerical aperture is given by the sin θ where θ the angular semi-aperature (on the object side) of the lens multiplied by the refractive index of the object space. Thus from a geometric viewpoint as the object to lens distance becomes larger, the sin θ becomes smaller and the depth of focus becomes larger inversely as the square of the numerical aperture, i.e.

D=λ÷(4×(N.A.)²)=(λ/n²)÷(4×sin²θ)

Since for the low power lens train the distance from the object to the lens acutally stays the same, the net effect of the low power lens train is to change the location of the principal planes, thereby in effect lengthening the object to lens (i.e., principal plane) distance, resulting in a smaller θ, thereby increasing the depth of focus. On the other hand, the light gathering power of the lens system and also the resolving power depend on the entrance pupil. In the present case since the N.A. of a 100× objective can be as high as 1.4 (for the 100× image), the same N.A. applies to the 20× image as well, a result not possible with an actual high dry 20× objective.

One cannot take advantage of the large specimen area imaged by the microscope's high power objective lens because the image of this large specimen area is bowl shaped and not flat, and the focused image from the objective lens alone at the focal plane of the lens is generally several feet in diameter. The present invention corrects these high power objective lens limitations and by correcting these high power objective lens limitations, this invention also permits, not only high power viewing, but also the use of the high power objective lens for low power viewing of a specimen. With the present invention, the light beam is split with a first light path for the high power (100×) image as normally shown to a first ocular, and a second light path is passed through a corrective lens train to form at the low power (20×) image shown to a second ocular.

To see the entire area of the specimen imaged through a microscope's high power objective lens, the light rays are passed through a lens train that reduces the diameter of the final image to a size suitable for viewing with a second ocular. Because the entire area of the specimen seen through a microscope's high power objective lens is comparable to that seen with a microscope's low power (20×) objective lens, by reducing the diameter of the final image to a size suitable for the second ocular, one can create a low power image through a high power objective lens. There is, however, a direct relationship between the area of the specimen imaged and the depth of focus seen with imaging lenses. The larger the area of the specimen imaged, the greater is the depth of focus. Thus even though the image is bowl shaped, the entire image appears in focus as shown by the above given formula, and becomes the low power 20× objective image as seen in the final ocular.

By splitting an image into two beams after the image passes through a microscope's high power objective lens and by sending one beam through the original optics required for the high power image, and by sending the second beam through the reducing image lens train to form the low power image, one can see both a high and low power image at the same time, with the high power image appearing as an enlargement of the middle of a small part of the specimen seen in the low power image.

By using the above invention, one can eliminate some of the major operational problems of an optical microscope. Ordinarily, a five step process is used for examining a specimen under a high powered objective lens as follows: (1) locate an object of interest using a low power objective lens; (2) focus the microscope on the desired field of view; (3) apply oil to the specimen slide; (4) change to the high power objective lens; and (5) focus the microscope with the microscope's fine adjustment knob on the desired object of interest on the specimen.

A 20× objective lens is generally used with only air between the bottom surface of the lens and the top of the specimen slide. Such a lens is called a “high-dry” objective, and generally all 20× objectives are designed to be used this way. On the other hand, for a 100× objective lens, a drop of oil must be placed on the top of the specimen slide so that when the 100× objective lens is used, the oil drop is between the bottom of the 100× lens and the top of the specimen slide. Such a lens is called an “oil” objective, and all good 100× objectives (with high N.A.) are designed to be used this way.

A problem arises when searching the specimen for another area of interest with the 20× objective. Since the 20× objective lens is designed to be used with only air between the objective and the slide, the oil must first be cleaned off the slide. This requires removing the slide, cleaning the oil off, and replacing the slide on the microscope and repeating the five steps above. The oil must, again, be placed between the lens and the specimen slide when the 100× objective lens is used, as before. Since this procedure is quite tedious, in the cause of efficiency the microscopist will often take a shortcut, and attempt to view through the 20× with some oil still smeared on the slide, or try to use the 100× with no oil. Since the 20× objective lens is designed for air between the lens and the slide, and the 100× is designed for oil between the lens and the slide, the shortcut mentioned above severely degrades the image seen by the microscopist and is unsatisfactory. Nevertheless, the microscopist is tempted to take the shortcut as a trade-off with accuracy to preserve efficiency. The present invention eliminates the above problem.

The present invention also has cost advantages when using a microscope with a computer controlled stage. Expensive optical microscopes can cost $100,000 or more. Much of the cost of these expensive microscopes comes from the cost of the mechanical and computer systems for moving the stage very accurately to within a few microns.

The present invention also dramatically reduces the cost of a microscope by bypassing most of the sophisticated mechanical and computer control methods through the simultaneous user-interaction with both high and low power images. It is inexpensive to have a mechanical arrangement that allows the computer to reposition the specimen to within the field of a 20× objective lens. The user can recognize near the center of this area in the 20× image the object or area of interest for viewing at a 100× objective. Using computer keys, the user can interactively move the microscope stage in the proper directions while observing both the 20× and 100× images at the same time to accurately position the stage so that the object or area of interest appears in the 100× objective viewing display. Because of the user interaction, the present invention greatly increases the flexibility of the microscope and eliminates he need for expensive sophisticated mechanical components and computer software.

Also from the user's viewpoint, it is required to store in a computer the exact location and focus position of the high power image. Presently, to reposition the specimen to see the same high power image at a later session requires extremely precise mechanical components that will reposition the specimen to within a few microns. However, with the present invention, the repositioning mechanics need not be expensive, because even if the specimen is not postioned perfectly, the user can see both the low and high power images, and can interactively adjust the position of the specimen to center the high power image accurately.

The following patents are generally pertinent to the present invention: U.S. Pat. Nos. 4,651,200; 4,673,973; 4,769,698; and Re.33,883.

### DRAWING FIGURES

FIG. 1 shows a frontal view of the invention

FIG. 2 shows the internal construction of the high power lens train tube (17) and details of the beam splitter (13).

FIG. 3 shows the internal construction of the low power lens train tube (21) and details of the beam splitter (13).

FIG. 4 shows a side view of a microscope with the concurrent high and low power optical system attached.

FIG. 5 shows a detailed illustration of the microscope stage area with motors (7) for electronic movement of the stage and an X coordinate position sensor (77).

FIG. 6 shows a detailed illustration of the electronic focus system modification of a microscope with the concurrent high and low power optical system attached.

### DETAILED DESCRIPTION OF THE PREFERRED EMBODIMENTS

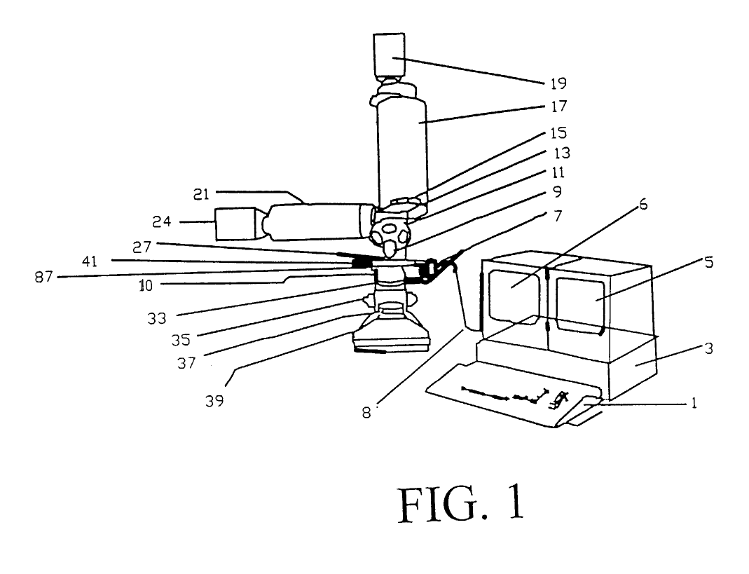

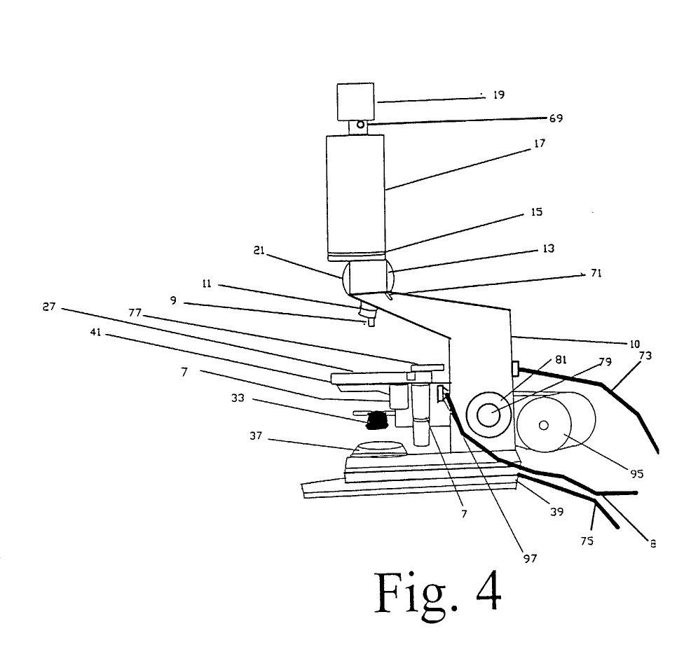

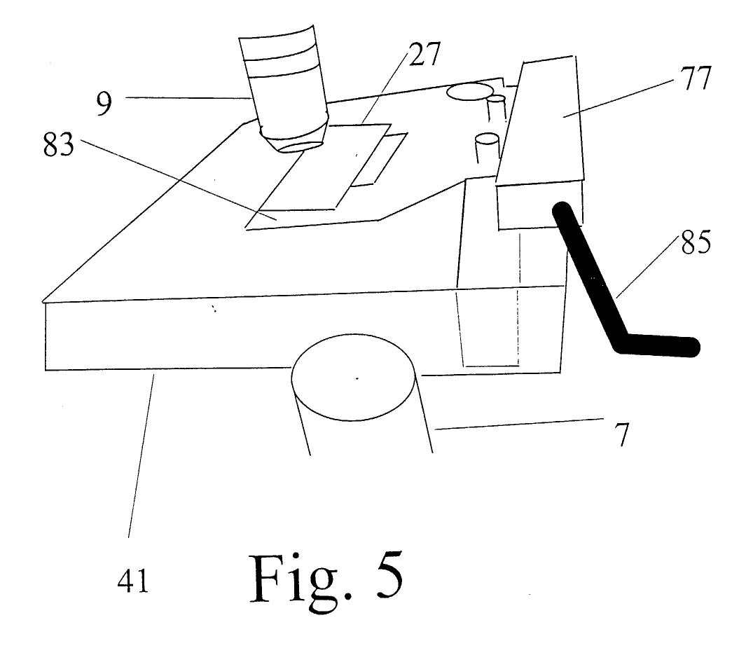

The preferred embodiment of this optical system for enhancing the image from a microscope's high power objective lens is illustrated in FIGS. 1 and 4. The preferred embodiment consists of a high power video camera 19, for the high power image, attached to a high power lens train tube 17. Said high power video camera 19, which is attached to the high power lens train tube 17 by attachment screw 69, produces a video image which is transferred via a video cable to the high power video monitor 5. The high power lens train tube 17 is attached to the beam splitter housing 13. The beam splitter housing 13 is attached to a conventional microscope's arm 10 by inserting a key located on the base of the beam splitter housing 13, into the existing recess 71 in the microscope's arm 10. Also attached to the beam splitter housing 13 is the low power lens train tube 21 and a nose piece 11 with its high powered objective lens 9. Attached to said low powered lens train tube 21 is the low power video camera 24, for the low power image, that transfers a video image via a video cable to the low power video monitor 6. The high power lens train tube 17, the beam splitter housing 13, and the low power lens train tube 21 are supported by the microscope arm 10. Said arm terminates in the microscope base 39. Also attached to said microscope base 39 is a microscope light source that is powered by an electrical cable 75, an aperture 37, and a computer controlled movable stage 41 with a condenser 33. The specimen 27 is placed on the stage 41. The stage 41 is moved by X & Y stage motors 7 (also see FIG. 5). All motors receive their power from a motor supply cable 73. The X & Y stage motors 7, which are pulsed analog motors, adjust the position of the specimen 27 relative to the objective lens 9. The X & Y stage motors 7 can also be stepping motors. These X & Y stage motors 7 manipulate the stage 41 by turning the microscope's existing mechanical stage moving mechanisms via a v-belt attached to said X & Y stage motors 7 and the microscope's mechanical stage moving mechanisms. They are controlled by the computer 3 and its keyboard 1. The fine up and down movement of the stage 41 and thus the fine focus of the microscope is controlled by motorized focus controls 35 powered by the focusing motor 95. The coarse focusing control of the microscope is effected by turning the coarse adjustment knob 81. Fine focusing can also be adjusted by using the fine focusing knob 79. The motorized focus controls 35 is controlled by the keyboard 1 through the computer 3. To survey the specimen area, the stage 41 is automatically moved in a zig-zag pattern by the X & Y stage motors 7, which are under the control of the computer 3. The computer 3 controls the motors mounted on the microscope and receives position information through a RS 232 cable 8 connected to a RS 232 cable connector 97. The position of the specimen is determined by the computer 3 by monitoring the digitized change in resistance generated by the movement of an electrical contact mounted on the movable portion of the stage 41 along a resistance strip inside the y position sensor 87 or inside the x position sensor 27 (see also FIG. 5 element 77). These resistance strips are located inside the position sensors. The analog data from the RS 232 cable 8 is converted to a digital signal by A to D converters mounted on computer boards installed in the computer 3. The digital data from the computer 3 is converted, as needed, to an analog signal through D to A converters located on computer boards installed in computer 3. The specimen location is automatically x-y indexed within the scanning field. This index information is stored in the computer 3. The computer 3 can also label an indexed an object and at any time manipulate the stage 41 to return to any indexed coordinate.

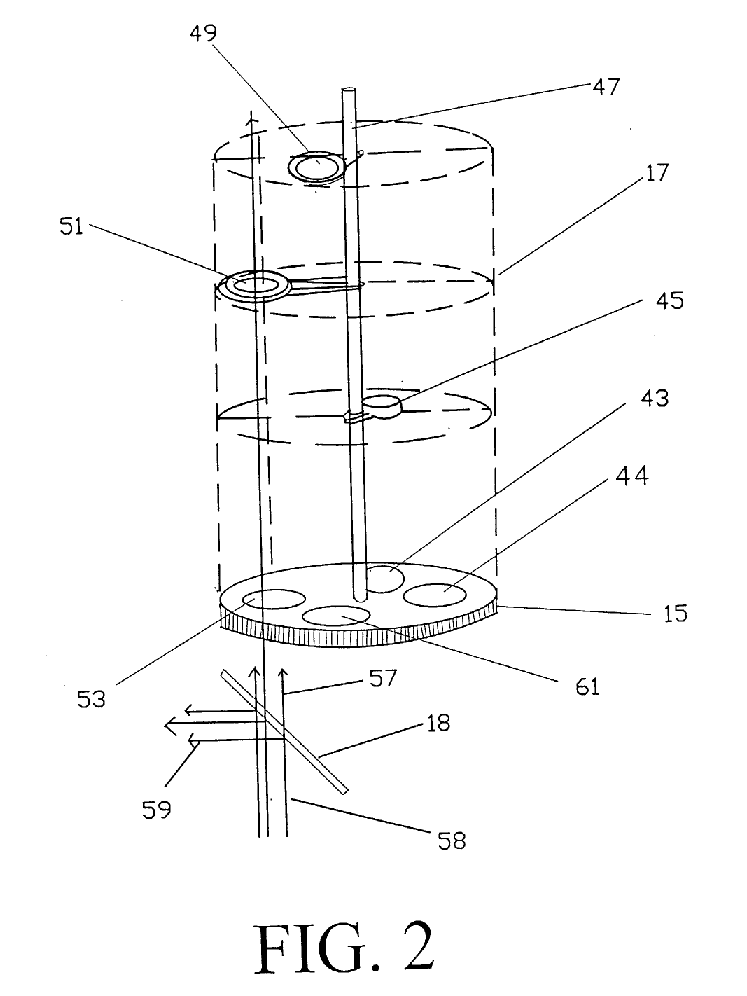

FIG. 2 shows the internals of the high power lens train tube 17 and of the beam splitter housing 13. The high power lens train tube 17 contains magnification lenses that are mounted on a rotating shaft 47 at critical distances from the beam splitter for the desired magnification. These mounted magnification lenses are rotated into position by turning the thumb wheel 15 at 90 degree increments. In position 1, the light from the objective lens passes through the 4.5× window 61, then through the 4.5× magnification ocular lens 49 and then into the high power video camera 19. In position 2, the light from the objective lens passes through the 5× window 53, then through the 5× magnification ocular lens 51 and then into the high power video camera 19. In position 3, the light from the objective lens passes through the 6× window 43, then through the 6× magnification ocular lens 45 and then into the high power video camera 19. In position 4, the light from the objective lens passes through the 10× lens 44 and then into the high power video camera 19.

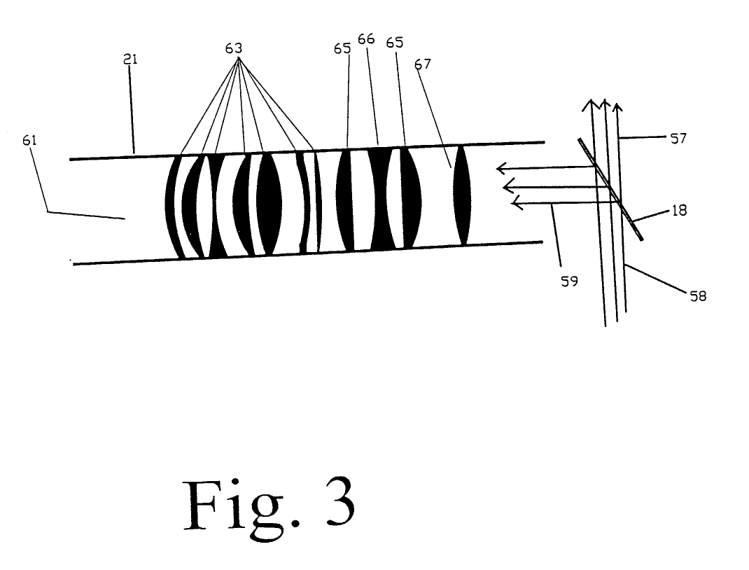

FIG. 3 is an illustration of the internals of the low power lens train tube 21 and the beam splitter housing 13. The low power lens train tube 21 contains a field lens 67, a collecting lens set consisting of two convex lenses 65, and one concave lens 66. The three lenses in the collecting lens set collimate the light from the field lens 67 (this three lens set is an “off the shelf” Kodax Ektrgraph flat-field slide projection lens set). The focusing lens set 63 is an “off the shelf” Nikon flat-field f=55 mm lens set.

FIG. 2 and FIG. 3 contain illustrations of the internals of the beam splitter housing 13. The incident light 58 passes through the specimen to the beam splitter 18, where it is split into two parts. The beam splitter 18 is set at an angle of 45 degrees from the incident light 58. Half of the incident light 58 is reflected towards the low power lens train tube 21; this light path is the low power optics reflected light pathway (low power beam) 59. The other half is transmitted through the beam splitter 18 to the high power lens train tube 17; this light path is the high power optics transmitted light pathway (high power beam) 57.

FIG. 5 shows the stage area of the microscope. The specimen 27 is held in position by a specimen holder 83 on the microscope's stage 41. The microscope's stage is conventional in design with a fixed and a moving part. The objective lens 9 is located above the specimen 27. The X position sensor 77 is mounted on the microscope's stage 41. Resistance information for the X position sensor is relayed to the computer via a resistance wire 85.

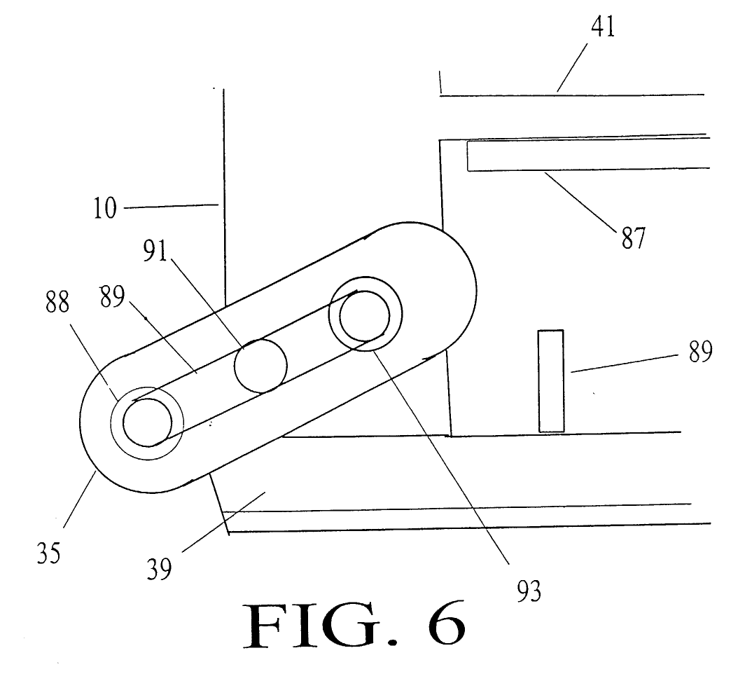

FIG. 6 shows a detailed illustration of the electronic focus system modification of a microscope with the concurrent high and low power optical system attached. The motorized focus control 35 consists of a driving gear 88 mounted on the shaft of the focusing motor 95 (see FIG. 4). An intermediate gear 91 and a fine focusing gear 93 mounted on the microscope's conventional fine focusing mechanism. Power is transferred from the driving gear 88 to the fine focusing gear 93 by a chain 89. The motorized focus control is mounted on the microscope's arm 10 and base 39. A reset switch 89 is activated when the stage 41 reaches its lowest position. This reset switch 89, when activated, resets the position of the stage to zero. FIG. 6 also shows the Y position sensor 87. The Y position sensor is mounted under the microscope's stage 41.

### Operation—FIGS. 1 through 6

The concurrent high and low powered optical system operates by placing a specimen on the microscope's stage 41 within the specimen holder 83. Rather than beginning the examination of the specimen 27 under a low powered objective lens, the specimen is prepared for viewing under a high powered objective lens. Using the computer keyboard 1, the operator instructs the computer 3 to calibrate the microscope. The computer 3 activates the motorized focus control 35 and the stage 41 will then descend until the reset switch 89 is mechanically tripped by descent of the stage 41. When the reset switch 89 is tripped, the computer 3 receives a signal that indicates that the stage is in a zero position for focus. Simultaneously, the computer 3 activates the X and Y stage motors 7. Using the X and Y stage motors 7, the computer 3 will move the stage 41 in X and Y directions until the X position sensor 77 and the Y position sensor 87 send information to the computer that the stage 41 is at its zero position (lowest resistance). The operator then adjusts the thumb wheel 15 to the desired high power magnification. Using the keyboard 1, the operator instructs the computer 3 to begin a scan. When the operator observes the relevant field of view on the low power video monitor 6, using the keyboard 1, the operator focuses the microscope until the operator sees a clear image of the specimen 27. Using the keyboard 1, the operator then locates and instructs the computer 3 to index the boundary positions of the specimen area of the specimen 27. The operator then can instruct the computer 3 via the keyboard 1 to begin a scan. The computer 3 will move the stage via the X and Y motors 7 in a predefined scanning pattern. If necessary, the operator can adjust the magnification by turning the thumb wheel 15. When an interesting object is observed on the low power video monitor 6 and the high powered video monitor 5, the microscope can, if necessary, be focused using the keyboard 1. The object can then be examined and indexed by pressing a key on the keyboard 1. Again, if necessary, the magnification can be increased by turning the thumb wheel 15.

### SCOPE OF INVENTION

Although the description above contains many specifications, these should not be construed as limiting the scope of the invention, but as merely providing illustrations of some of the presently preferred embodiments of this invention. For example, the magnification of the lens in the high power lens train tube 17 and the low power lens train tube 21 can be changed. It is even conceivable that, some of the magnifying and collimating lenses could be replaced with mirrors or that the high and low power lens train tubes could be made more compact by using one or more prisms.

One could use a flip mirror, rather than a beam splitter 18 to send the light beam through the high power optics to see the high power image train tube or flip the mirror sending a light through the low power image train tube to see the low power image.

The way that the mechanical focus and stage position adjustments are motorized in this invention is to some extent dictated by the choice of the microscope to be modified. It is conceivable that the focus adjustment could be made using a single step motor attached directly to the fine focus mechanism or to the mechanical stage position mechanism.

The positions sensors 87 and 77 could use resistance, optical sensors, capacitance or mechanical movement sensors to locate the position of the x and y position of the stage 41.

In the present embodiment of this invention, the stage is moved to examine the specimen, but it is also conceivable that the stage could be fixed and that the optics could be moved.

The images in the present embodiment are conveyed to monitors through cables, but the images could also be conveyed to the monitors directly by a fiber optic connection.

The two beams created by the beam splitter could be directed through a fiber optic connection to optical and/or electronic magnification systems.

The scanning pattern used by the computer to locate objects can be zig zag, spiral or any other workable scanning pattern.

There can be multiple high power images, and multiple low power images seen at the same time or seen serially depending on the particular application.

Thus, the scope of the invention should be determined by the appended claims and their legal equivalents, rather than by the examples govern.

I claim:

1. A microscope with an enhanced high power objective lens comprising:
a. a means of splitting a light image beam of a specimen from a microscope's high power objective lens into two or more light image beams;
b. a means of using one of the said light image beams to produce a high power image of a small area of the specimen;
c. a means of reducing the magnifications of one or more of the said light image beams to a low magnification to produce low power images of a much larger area of the specimen;
d. a means of reducing the diameter of the said light image beams from said microscope's high power objective lens to diameters suitable for viewing;
e. a means of observing the magnified images from both beams; and
f. a means of conveying said low power images and said high power images to said means of observing the magnified images.

2. A microscope with an enhanced high power objective lens comprising:
a. a means of directing a light image of a specimen from a microscope's high power objective lens into either high or low power lens train tubes;
b. a means of directing said light image from said microscope's high power objective lens to a high power lens train tube to produce high power images;
c. a means of directing said light image from said microscope's high power objective lens to one or more low power lens train tubes to produce low power images;
d. a means of reducing the diameter of said light images from said microscope's high power objective lens to sizes suitable for viewing;
e. a means of observing said high power or said low power images; and
f. a means of conveying said low power image and said high power image to said means of observing said high power or said low power images.

3. A microscope as in claim 1, or claim 2, wherein said means of observing said high and low magnification images is from two or more beams at the same time, viewed through two or more monitors set up in tandem.

4. A microscope as in claim 1, or claim 2, wherein said means of observing said images from two or more beams, through one monitor with one or more demarcated areas of the screen for observing said high power image and one or more demarcated area of the screen for observing said low power images.

5. A microscope as in claim 1 or claim 2 with means for enlarging the high power beam to various high power magnifications.

6. A microscope as in claim 1 or claim 2 with means for reducing the high power beam to various low power magnifications.

7. A microscope as in claim 1 or claim 2 with means for enlarging or reducing the magnification of the light image beams.

8. A microscope as in claim 1 or claim 2 with means for viewing the various magnification images serially one at a time or in parallel at the same time.

9. A microscope as in claim 1, or claim 2, wherein said means of conveying said low power and said high power images to said means of observing the magnified image, is through cables attached to video cameras.

10. A microscope as in claim 1, or claim 2 wherein one or more beam splitters are used as a means of splitting a light image of a specimen into two or more beams.

11. A microscope as in claim 1, or claim 2, wherein said means of magnifying said light image from one of the said beams to produce various high power magnifications, is by directing one of said beams from said high power microscope objective lens through a high power lens train tube; and whereby said microscope is capable of producing from said high power lens train tube various high power magnified images.

12. A microscope as in claim 1, or claim 2, wherein said means of magnifying said light image from one or more of the said beams to produce said low power images, is by directing each one of said beams from said high power microscope objective lens through low power lens train tubes; whereby said microscope is capable of producing from each said low power lens train tubes a low power magnified image as normally produced by a low power objective lens; and whereby a single magnified image produced from a single high power objective lens can be processed to produce both low and high power magnified images as would otherwise be produced directly by low or high power magnifying objective lens.

13. A microscope as in claim 12, wherein each said low power lens train consists of a field lens, a collecting lens set, and a focusing lens set.

14. A microscope as in claim 1, or claim 2, wherein said specimen's position relative to the optics is changed by moving a microscope stage.

15. A microscope as in claim 1, or claim 2, wherein said means for observing the magnified images from two or more of the beams can be observed simultaneously.

16. A microscope as in claim 1, or claim 2, wherein the normally smaller area of the specimen seen in a said high power image is shown in a small area part of the normally larger area of the specimen seen in said low power images.

17. A microscope as in claim 1, or claim 2, wherein the lower power images appear as having been produced by a lens having the same numerical aperture rating as the said high power objective lens.

18. A microscope as in claim 1, or claim 2, wherein said microscope does not require changing lenses to switch between a high magnification power view and a low magnification power view of the specimen.

19. A microscope as in claim 1, or claim 2, wherein said microscope has a motorized mechanism such that the position of the microscope's stage relative to the bottom of the single objective lens can he moved in the X, Y, and Z directions.

20. A microscope as in claim 1, or claim 2, having an associated computer and software system; and wherein said software system uses on-line interactive data and previously stored data to compute relative movement required and to actuate the movement by sending signals to the motorized mechanisms.

21. A microscope as in claim 20, wherein said microscope has the capability of sending to the computer its current numerical relative position X, Y, and Z values.

22. A microscope as in claim 20, wherein the user inputs on-line the interactive data onto said computer while viewing the microscope's images.

23. A microscope as in claim 20, wherein said computer permits, at any instant of time, the user to interactively direct the computer to store the relative position X, Y, and Z values.

24. A microscope as in claim 21, wherein said stored relative positions can be used to reposition said specimen to stored relative positions.
